(19) United States
(12) Patent Application Publication
(10) Pub. No.: US 2005/0129489 A1
(43) Pub. Date: Jun. 16, 2005

(54) Load lock and load lock chamber using the same

(76) Inventors: Yong Chun Quan, Seoul (KR); Bu Jin Ko, Seoul (KR); Jae Wook Choi, Seoul (KR)

Correspondence Address: MARGER JOHNSON & MCCOLLOM, P.C., 1030 SW MORRISON STREET, PORTLAND, OR, 97205, US

(21) Appl. No.: 10/987,600

(22) Filed: Nov. 12, 2004

(30) Foreign Application Priority Data
Dec. 11, 2003 (KR) 10-2003-0079888
Oct. 26, 2004 (KR) 10-2004-0085638

(51) Int. Cl. B65G 1/00

(52) U.S. Cl. 414/217

(57) ABSTRACT

Disclosed herein is a load lock to be on standby after loading a plurality of substrates in cooperation with a transfer means adapted to transfer the substrates from process chambers in turn. The present invention provides the load lock which increases the transfer rate thereof to efficiently transfer the substrates to the process chambers or the exterior, and a load lock chamber using the load lock. According to the present invention, the load lock includes a plurality of substrate support panels which support the substrates thereon, are movable vertically, and are spaced apart from each other by a distance that is greater than the thickness of the substrate, and drive units for vertically moving at least one of the substrate support panels.

This application claims the priority of Korean Patent Application No. 2003-79888, filed on Nov. 12, 2003, in the Korean Intellectual Property Office, the disclosure of which is incorporated herein in its entirety by reference.

### BACKGROUND OF THE INVENTION

1. Field of the Invention

The present invention relates generally to a load lock to load or unload a plurality of substrates onto or from a process chamber in cooperation with a transfer means adapted to transfer a substrate, such as a semiconductor, a liquid crystal display (LCD), or an organic light emitting display (OLED), and more particularly, to a load lock and a load lock chamber using the same, capable of increasing a substrate transfer rate, and efficiently transferring substrates to a process chamber.

2. Description of the Related Art

FIG. 1a is a schematic plan view of a general multi-chamber-type substrate processing apparatus including a load lock. The apparatus includes a transfer chamber 1 at a center thereof. One or two load lock chambers 2 or 102 are coupled to the transfer chamber 1. The apparatus also includes a plurality of process chambers 3. A transfer unit 4 is installed in the transfer chamber 1. That is, a plurality of process chambers 3 and one or two load lock chambers 2 are provided around the transfer chamber 1. The process chambers 3 serve to process a substrate, with semiconductor manufacturing processes including a thin film deposition, a substrate heating process, a substrate cooling process, a thin film etching process, etc. executed in the process chambers 3.

A single-slot load lock chamber having a single slot therein is frequently used for the conventional load lock used in the general substrate processing apparatus.

Each load lock chamber 2 includes a first gate communicating with the transfer chamber 1 and a second gate communicating with an outside atmosphere, thus loading or unloading the substrate. An exhaust unit is coupled to the load lock chamber 2 to pump air out of or into the load lock chamber 2, thus creating a vacuum environment or an atmospheric environment in the load lock chamber 2. The transfer unit 4 approaches a side around a gate of the load lock. At this time, the air exhaust unit is not operated and the gate is opened. Subsequently, the transfer means is driven to load a substrate onto a slot provided in the load lock chamber using an arm. Next, the arm of the transfer means retreats from the load lock chamber 2. After the gate is closed, air is exhausted from the load lock chamber 2, thus forming a vacuum in the load lock chamber 2. When an interior of the load lock chamber 2 reaches a predetermined vacuum level, the gate communicating with the transfer chamber 1 is opened, and the transfer unit 4 unloads the substrate from the load lock chamber 2 and transfers the substrate to a predetermined process chamber using the arm. Conversely, when it is desired to transfer the substrate from the process chamber to the exterior, the aforementioned operation is executed in reverse order.

If a substrate loading or unloading rate of the load lock is slower than a substrate processing rate of the process chamber, the process chamber is empty or must stand by while storing the finished substrate therein after the substrate process has been completed. This may frequently occur when there are a plurality of process chambers or a processing time is short as in a thin film treatment. Such problems can be solved by increasing the number of load locks. However, numbers of the load locks cause the entire size of the substrate processing apparatus to increase. FIG. 1b is a sectional view taken along line II-II of the load lock chamber 102 of FIG. 1a. As shown in FIG. 1b, although the number of slots is increased to support a plurality of substrates in the load lock chamber, a space in the chamber for accommodating a robot arm as well as the substrate must be made between the slots to load/unload the substrate, thus increasing the size of the load lock chamber. Further, as the space in the chamber increases, it takes a longer time to pump air out of the chamber, thus wasting energy and reducing productivity.

### SUMMARY OF THE INVENTION

Accordingly, the present invention is conceived to solve the above problems in the prior art. An object of the present invention is to provide a load lock and a load lock chamber using the same, capable of increasing the substrate transfer rate of the load lock which loads a plurality of substrates thereon and is on standby, thus efficiently transferring the substrates to a process chamber or the exterior.

Another object of the present invention is to provide a load lock and a load lock chamber, which are designed to accommodate a plurality of substrate support panels without the necessity of making an additional space for loading/unloading a substrate, thus minimizing the size of the load lock chamber and maximizing the substrate transfer capacity.

According to an aspect of the present invention for achieving the objects, there is provided a load lock, comprising a housing; a first substrate support panel installed in the housing; a second substrate support panel placed above the first substrate support panel to be spaced apart from the first substrate support panel; and a drive unit to vertically move at least one of the first and second substrate support panels, thus making a space between the first and second substrate support panels in order to load or unload a substrate.

Preferably, one of the first and second substrate support panels is fixed, and the other one of the first and second substrate support panels is coupled to the drive unit and moves upward or downward, thus making the space for loading or unloading the substrate.

More preferably, the drive unit is coupled to each of the first and second substrate support panels, the first substrate support panel moving upward and the second substrate support panel moving downward to make the space for loading or unloading the substrate.

The load lock may further comprises substrate support protrusions, on which the substrate is seated, provided on each of the first and second substrate support panels to have a function of an alignment of the substrate.

Furthermore, the load lock may further comprises a substrate feeding unit to load or unload the substrate onto or from each of the first and second substrate support panels; and one or more concave parts provided on each of the first and second substrate support panels to allow the substrate feeding unit to move.

More preferably, each of the first and second substrate support panels comprises a cooling and/or heating unit.

According to another aspect of the present invention, there is provided a load lock, comprising: a housing; a first substrate support panel installed in the housing; a second substrate support panel placed above the first substrate support panel to be spaced apart from the first substrate support panel; a third substrate support panel placed above the second substrate support panel to be spaced apart from the second substrate support panel; and a drive unit to vertically move at least one of the first to third substrate support panels, thus making a space between the first and second substrate support panels or between the second and third substrate support panels for loading or unloading a substrate.

Preferably, the first substrate support panel is fixed, and the drive unit comprises first and second drive units coupled to the second and third substrate support panels, respectively, the first and second drive units moving upward to make the space between the first and second substrate support panels and the space between the second and third substrate support panels, respectively, for loading or unloading the substrate.

More preferably, the drive unit comprises an air cylinder.

Also, each of the first to third substrate support panels may comprise a cooling and/or heating unit.

More preferably, the first substrate support panel is fixed, and the drive unit moves horizontally in order to selectively vertically move one of the second and third substrate support panels.

More preferably, the first substrate support panel is smaller than the second substrate support panel, and the second substrate support panel is smaller than the third substrate support panel, in order to provide a space for accommodating the drive unit coupled at a predetermined position around an inside wall of the housing.

The load lock may further comprises substrate support protrusions, on which the substrate is seated, provided on each of the first to third substrate support panels to have a function of an alignment of the substrate.

According to a further aspect of the present invention, there is provided a method of driving a load lock comprising a housing, a first substrate support panel installed in the housing, a second substrate support panel placed above the first substrate support panel to be spaced apart from the first substrate support panel, and a drive unit to vertically move at least one of the first and second substrate support panels, the method comprising: making a space above the first or second substrate support panel for loading or unloading a substrate by moving at least one of the first and second substrate support panels upward or downward; and loading or unloading the substrate onto or from the first or second substrate support panel.

According to a still further aspect of the present invention, there is provided a method of driving a load lock comprising a housing, a first substrate support panel installed in the housing, a second substrate support panel placed above the first substrate support panel to be spaced apart from the first substrate support panel, a third substrate support panel placed above the second substrate support panel to be spaced apart from the second substrate support panel, and a drive unit to vertically move at least one of the first to third substrate support panels, the method comprising: making a space above one of the first to third substrate support panels for loading or unloading a substrate, by vertically moving one of the first to third substrate support panels; and loading or unloading the substrate onto or from at least one of the first to third substrate support panels.

According to a still further aspect of the present invention, there is provided a load lock, comprising: a plurality of substrate support panels spaced apart from each other by a predetermined interval which is larger than a thickness of a substrate, each of the substrate support panels moving vertically and supporting the substrate on an upper surface thereof; and a drive unit for vertically moving at least one of the substrate support panels.

### BRIEF DESCRIPTION OF THE DRAWINGS

The above and other objects, features and advantages of the present invention will be more clearly understood from the following detailed description taken in conjunction with the accompanying drawings, in which:

FIGS. 1a and 1b are schematic views of a conventional substrate processing apparatus;

FIGS. 2a and 2b are schematic side sectional views of a load lock according to the present invention;

FIG. 3 is a schematic side sectional view of a load lock according to the present invention;

FIG. 4 is a perspective view showing an example of a middle substrate support panel of the load lock according to the present invention;

FIG. 5a is a top plan view showing another example of the middle substrate support panel of the load lock according to the present invention;

FIG. 5b is a side sectional view of the middle substrate support panel taken along line IVB-IVB of FIG. 5a;

FIGS. 6a to 6c are side sectional views of the load lock chamber taken along line IVB-IVB of FIG. 5a illustrating positions of a substrate and substrate support panels, when the substrate is loaded onto or unloaded from each of upper, middle, and lower substrate support panels; and

FIGS. 7a and 7b are side sectional views of the load lock chamber according to the present invention in which another example of a drive unit to drive each of the substrate support panels is employed.

### DESCRIPTION OF THE PREFERRED EMBODIMENTS

The preferred embodiments of the present invention will be described below in detail with reference to the accompanying drawings. However, the invention is not intended to be limited to the following embodiments and various changes and modifications may be made within the scope of the invention defined by the claims. The preferred embodiments are included merely to aid in the understanding of the invention. The same reference numerals are used throughout the different drawings to designate the same or similar components.

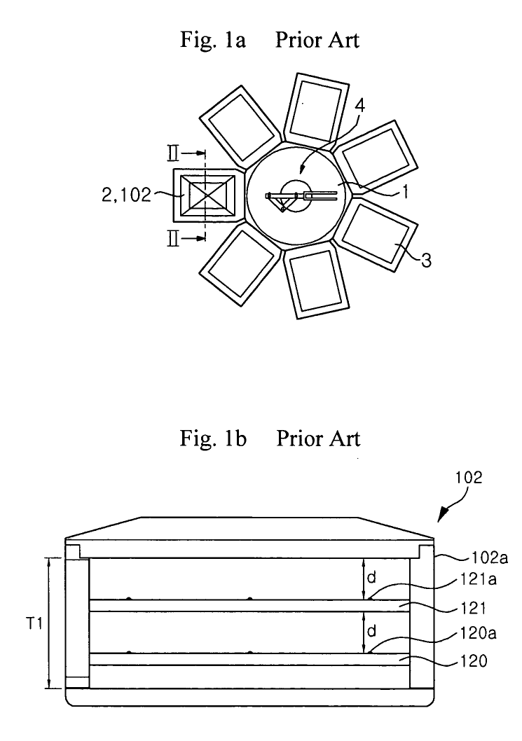

A substrate processing apparatus including a load lock chamber according to the present invention has the same construction as that of FIG. 1a. Similarly, a transfer unit 4 is provided at a center of a transfer chamber 1 which is coupled ounted to a sidewall of the load lock chamber 2. By an arm coupled to the transfer unit 4, a substrate loaded on a substrate support panel provided in the load lock chamber is transferred to a process chamber, or the substrate is transferred from the process chamber to the substrate support panel, prior to being fed to an exterior. The arm is constructed so that an object to be transferred, such as the substrate, is loaded on an end of the arm. The arm is constructed to suck and raise the substrate using a vacuum chuck or an electrostatic chuck, or to simply place the substrate on the end of the arm, or to raise and move the substrate to another position while holding the substrate with the vacuum chuck or the electrostatic chuck.

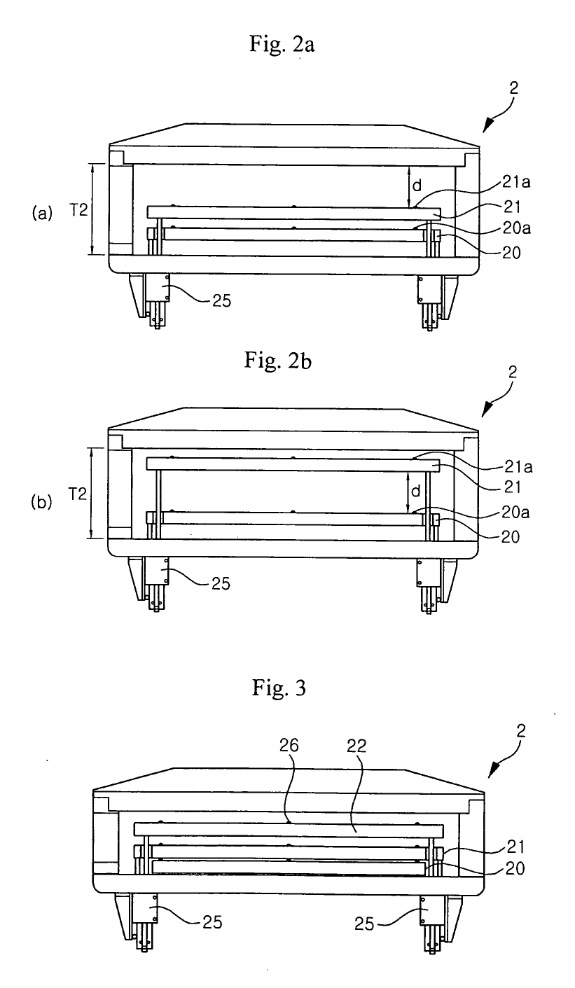

FIGS. 2a and 2b are sectional views taken along line II-II of the load lock chamber 2 of FIG. 1a to schematically illustrate a chamber where the load lock according to the present invention is installed, in which the load lock is on standby after loading two substrates. Referring to FIGS. 2a and 2b, the load lock chamber according to the present invention includes a housing, a first substrate support panel 20 installed in the housing, a second substrate support panel 21 placed above the first substrate support panel 20 to be spaced apart from the first substrate support panel 20 by a predetermined interval, and a drive unit 25 to vertically move at least one of the first and second substrate support panels 20 and 21, thus making a space between the first and second substrate support panels 20 and 21 for loading or unloading the substrate.

The first and second substrate support panels 20 and 21 further include substrate support protrusions 20a and 21a, respectively. The substrate support protrusions 20a and 21a serve to align the substrate and protect the loaded substrate. Further, a substrate feeding unit (not shown) and one or more concave parts (not shown) may be included. In this case, the substrate feeding unit is used to load or unload the substrate onto or from each of the first and second substrate support panels 20 and 21. The concave parts are provided on each of the first and second substrate support panels 20 and 21 to allow the movement of the substrate feeding unit. Further, each of the first and second substrate support panels 20 and 21 may further include a cooling unit (not shown) or a heating unit (not shown).

Thus, in order to load or unload two substrates using two substrate support panels 20 and 21 according to the prior art as shown in FIG. 1b, adjacent substrates must be spaced apart from each other by a predetermined distance d. Thus, an entire height T1 of the load lock chamber 2 should be inevitably increased corresponding to the distance 2d. However, according to the present invention, as shown in FIGS. 2a and 2b, at least one of the two substrate support panels moves, thus making sufficient distance d for loading the substrate. Thus, an entire height T2 of the load lock chamber 2 can be reduced corresponding to the distance d. The load lock constructed as above may be driven in various manners.

As an example, the case where one of the first and second substrate support panels 20 and 21 is fixed will be illustrated. Assuming that the first substrate support panel 20 is fixed, the second substrate support panel 21 is moved upward by the drive unit 25 to load or unload a substrate onto or from the first substrate support panel 20, thus making the space for loading or unloading the substrate. Next, the substrate is loaded onto or unloaded from the first substrate support panel 20 by the substrate feeding unit. Meanwhile, when a user desires to load or unload a substrate onto or from the second support panel 21, the second substrate support panel 21 is moved downward by the drive unit 25, thus making the space for loading or unloading the substrate. Subsequently, the substrate is loaded onto or unloaded from the second substrate support panel 21 by the substrate feeding unit.

Further, the case where the first and second substrate support panels 20 and 21 are not fixed will be described. In this case, when it is desired to load or unload a substrate onto or from the first substrate support panel 20, the first substrate support panel 20 is moved downward and the second substrate support panel 21 is moved upward by the drive unit 25. Thereafter, the substrate is loaded onto or unloaded from the first substrate support panel 20. Then, if it is desired to load or unload a substrate onto or from the second substrate support panel 21, the second substrate support panel 21 moves downward in order to load or unload the substrate onto or from the second substrate support panel.

Of course, the present invention may include a plurality of substrate support panels without being limited to two substrate support panels. Referring to FIG. 3, a load lock chamber having three substrate support panels will be described below.

FIG. 3 is a sectional view taken along line II-II of the load lock chamber 2 of FIG. 1a to illustrate a chamber where the load lock according to the present invention is installed, in which the load lock is on standby after loading a plurality of substrates. The load lock, which is on standby after loading substrates to be transferred to process chambers in turn or substrates to be transferred to the exterior, is installed in the load lock chamber 2. The load lock chamber 2 is sealed and pumped to exhaust air therefrom, thus forming a vacuum therein. As substrate support panels for loading or unloading a plurality of substrates in the chamber, three substrate support panels 20, 21, and 22 are provided. The substrate support panels 20, 21, and 22 are spaced apart from each other by predetermined distances and are vertically movable in the load lock chamber 2. A cooling or heating unit is installed to each of the substrate support panels 20 to 22 to cool or heat the substrates in the load lock chamber, as necessary. Further, there are provided gates (not shown) for communicating with the transfer chamber 1 and the exterior of the load lock chamber, respectively, to be opened or closed when loading or unloading the substrate. For example, the respective gates may be provided on front and rear sides of FIG. 3. When loading or unloading the substrate onto or from the exterior, the gate communicating with the transfer chamber 1 is closed, and the gate communicating with the exterior is opened, so that the interior of the load lock chamber 2 is under atmospheric pressure. On the other hand, when loading or unloading the substrate onto or from the transfer chamber 1, the gate communicating with the exterior is closed, and then air is pumped out of the load lock chamber 2 to form a vacuum in the load lock chamber 2, and subsequently the gate communicating with the carrier chamber 4 is opened. As an example of the drive unit to vertically move the substrate support panels, air cylinders 25 are used. The air cylinders 25 are provided on opposite ends of the substrate support panels 20, 21, and 22. The air cylinders provided on each of the substrate support panels are individually operated, thus allowing the substrate support panels to be spaced apart by predetermined intervals from each other. In this case, it is preferable that the lower substrate support panel 20 be fixed. Such a construction makes a predetermined space for accommodating the end of the arm above the substrate support panels on which the substrate is placed, when loading or unloading the substrate. Since the predetermined space is required above the substrate support panel on which the substrate is loaded or unloaded, the height of the load lock chamber 2 is minimized when the lower substrate support panel 20 is fixed. Thus, the air cylinders 25 are installed to vertically move the middle substrate support panel 21 and the upper substrate support panel 22, but not the lower substrate support panel 20. The air cylinders 25 may be coupled to an exterior or interior of the load lock chamber 2. The air cylinders 25 pass through holes of the middle substrate support panel 21 to be coupled to the upper substrate support panel 22.

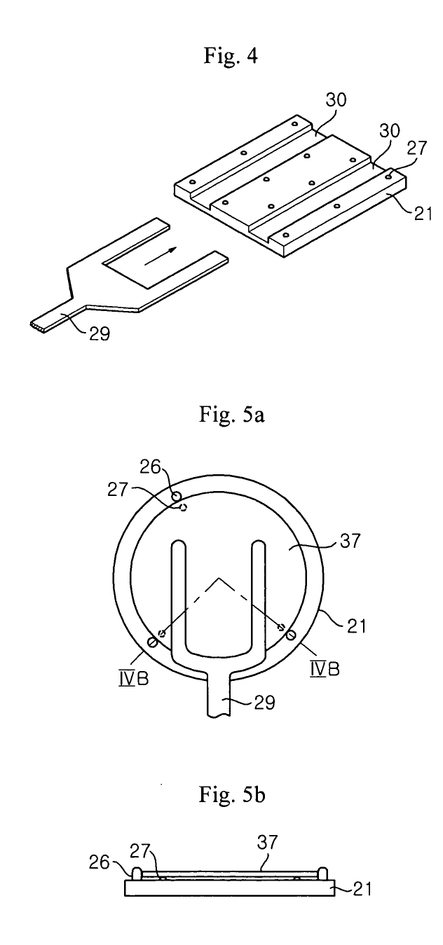

FIG. 4 is a perspective view showing the state where a substrate 37 is loaded onto or unloaded from the middle substrate support panel 21 of FIG. 3, for example, by means of an arm 29. A plurality of substrate support protrusions 27 are provided on the middle substrate support panel 21 and the substrate 37 is seated on the substrate support protrusions 27 in order to support the substrate 37. Thus the substrate 37 is allowed to be stably loaded on the middle substrate support panel 21, so that the substrate 37 is prevented from being dirty due to direct contact of the substrate 37 with the middle substrate support panel 21. In order to load or unload the substrate 37 onto or from the substrate support protrusions 27 using the arm 29, the middle substrate support panel 21 must have a predetermined space thereabove to allow the arm 29 to smoothly move from or to between the substrate and the middle substrate support panel 21. To make the predetermined space, concave parts 30 may be provided on the substrate support panel 21 in parallel with each other to allow forward and backward movement of the arm 29. For example, as shown in FIG. 4, when the substrate 37 is loaded or unloaded by the arm 29, each concave part 30 extends to be opened to front and/or rear ends of the substrate support panel. In this case, after the substrate is placed on the end of the arm 29 and inserted in the load lock, the substrate is positioned above the substrate support panel 21. Thereafter, the arm 29 moves downward, so that the substrate is seated on the substrate support protrusions 27. The end of the arm 29 is disposed in the concave parts 30 of the substrate support panel. Thus, when the arm 29 is retreated, only the arm 29 may move with the substrate being stationary. The concave parts 30 provided on the substrate support panel 21 increases a vertical moving distance of the end of the arm 29 between the substrate and the substrate support panel when the substrate is loaded or unloaded, thus allowing intervals between the substrate support panels to be reduced. Due to the reduction of the intervals between the substrate support panels, the volume of the load lock chamber may be reduced, or more substrate support panels may be provided in the same volume of the chamber. If the arm 29 transfers the substrate 37 by catching a peripheral part of an upper portion of the substrate 37, the concave parts 30 are not required.

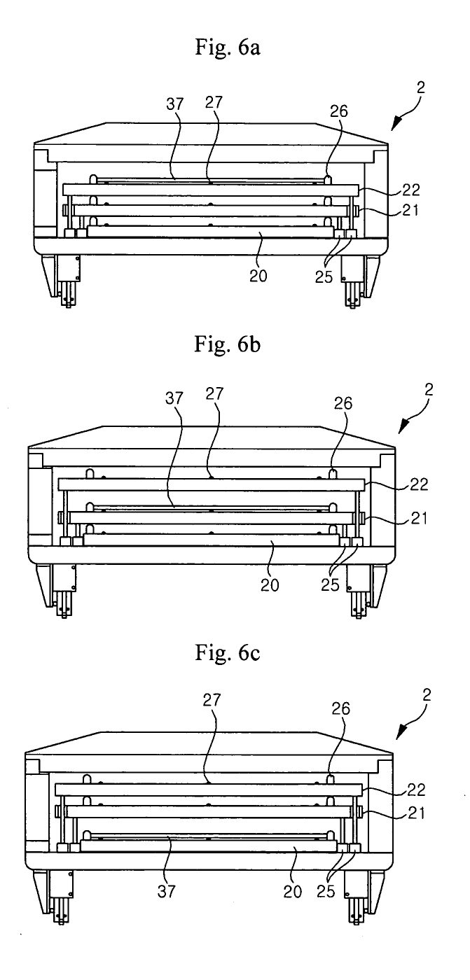

FIG. 5a shows another example of the substrate support panel and illustrates the state where the substrate 37 is loaded onto or unloaded from the middle substrate support panel 21 of FIG. 2, by the arm 29. FIG. 5b is a side sectional view of the middle substrate support panel taken along line IVB-IVB of FIG. 5a, with the arm omitted. As shown in FIGS. 5a and 5b, projections 26 may be further provided on each substrate support panel to make a predetermined space for allowing the substrate support panels to be spaced apart from each other by a distance which is larger than the thickness of the substrate, when the substrate is loaded onto the substrate support panels. That is, the projections 26 serve to make the predetermined space, thereby preventing the substrate from interfering with the substrate support panel just above the substrate. Further, the projections 26 also make an alignment of the substrate by bringing the substrate into contact with a side surface of each projection 26, when the substrate is loaded onto the substrate support panel 21. Further, the projections 26 may be provided on an outer peripheral portion of each substrate support panel of FIG. 4. Further, the substrate support protrusions 27 are provided on the substrate support panel 21 and the substrate 37 is seated on the substrate support protrusions 27 in order to support the substrate 37, thus allowing the substrate 37 to be stably loaded onto the middle substrate support panel 21, and preventing the substrate 37 from becoming dirty due to direct contact of the substrate 37 with the substrate support panel 21. In this case, the substrate support protrusions 27 are provided on the substrate support panel 21 to be vertically moved, thus allowing the substrate to be smoothly loaded or unloaded. That is, when the substrate 37 is placed on the end of the arm 29 and loaded onto or unloaded from the substrate support panel 21, the substrate support protrusions 27 move upward beyond the thickness of the arm 29, thus for example, allowing the arm 29 to retreat after placing the substrate 37 on the substrate support protrusions 27. After the arm 29 has retreated, the substrate support protrusions 27 move downward to return to original positions thereof. Meanwhile, in the case where the arm 29 transfers the substrate 37 by catching a peripheral part of an upper portion of the substrate 37, the vertical moving structure of the substrate support protrusions 27 is not required. FIGS. 6a to 6c are sectional views of the load lock chamber taken along IVB-IVB of FIG. 5a. The operation of the load lock according to the present invention will be described below with reference to FIGS. 6a to 6c.

As shown in FIG. 6a, when the substrate 37 is loaded onto or unloaded from the upper substrate support panel 22, the air cylinders coupled to the middle and upper substrate support panels 21 and 22 are driven to move the middle and upper substrate support panels 21 and 22 downward. Thus, a predetermined space is made between the upper substrate support panel 22 and the chamber so that the substrate 37 is loaded onto or unloaded from the upper substrate support panel 22 by a transfer unit (not shown) and the arm. As shown in FIG. 6b, when the substrate 37 is loaded onto or unloaded from the middle substrate support panel 21, only the upper substrate support panel 22 moves upward by the air cylinders coupled to the upper substrate support panel 22. In this case, a predetermined space is made between the upper substrate support panel 22 and the middle substrate support panel 21 so that the substrate 37 is loaded onto or unloaded from the middle substrate support panel 21 by the transfer unit and the arm. Similarly, as shown in FIG. 6c, when the substrate 37 is loaded onto or unloaded from the lower substrate support panel 20, the middle substrate support panel 21 and the upper substrate support panel 22 move upward, so that a predetermined space is made between the middle substrate support panel 21 and the lower substrate support panel 20. In this case, although the projections 26 are not provided on each of the substrate support panels, predetermined intervals between adjacent substrate support panels are maintained by the air cylinders coupled to the substrate support panels.

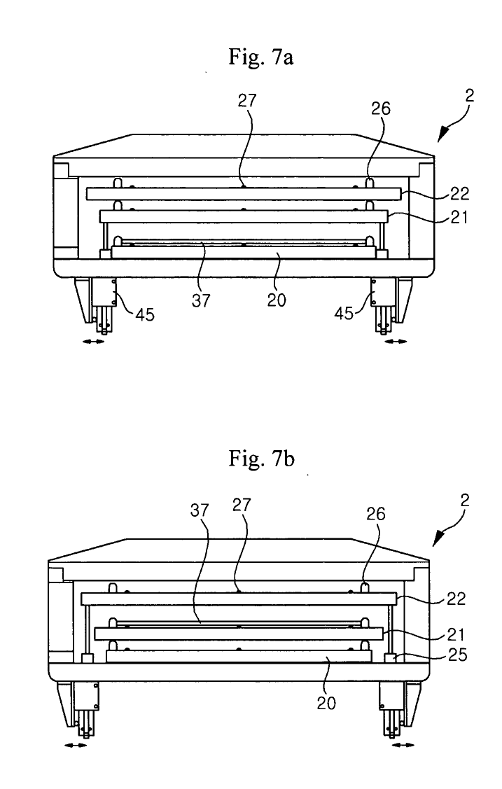

Another example of a unit for vertically moving the substrate support panels is shown in FIGS. 7a and 7b. As shown in the drawings, air cylinders 45 are provided on a bottom of the chamber to selectively or alternatively move to one of the substrate support panels in a radial direction of the substrate support panels. In this case, the projections 26 must be provided on the middle and lower substrate support panels 21 and 20. That is, since at least one of the upper and middle substrate support panels 21 and 22 is not supported by the air cylinders 45, the projections 26 are required to allow adjacent substrate support panels to maintain predetermined intervals. For example, as shown in FIG. 7a, when the substrate is loaded onto or unloaded from the lower substrate support panel 20, the air cylinders 45 move below a lower surface of the middle substrate support panel 21 to be coupled to the lower surface (or a side surface according to a feature of the substrate support panel 21) thereof, thus moving the middle and upper substrate support panels 21 and 22 upward. Thereby, a space for loading or unloading the substrate onto or from the lower substrate support panel 20 is provided. In this case, a lower surface of the upper substrate support panel 22 is in contact with the projections 26 provided on the middle substrate support panel 21, so that the middle substrate support panel 21 supports the upper substrate support panel 22. Thus, the middle substrate support panel 21 moves upward together with the upper substrate support panel 22. Meanwhile, as shown in FIG. 7b, when the substrate 37 is loaded onto or unloaded from the middle substrate support panel 21, the air cylinders are driven so that the upper and middle substrate support panels 22 and 21 are supported by the projections 26 provided on the middle and lower substrate support panels 21 and 20, respectively, and then the air cylinders are retreated to the maximum extent. Thereafter, the air cylinders 45 move the lower surface of the upper substrate support panel 22 to be coupled to the lower surface thereof, thus moving the upper substrate support panel 22 upward. At this time, the middle substrate support panel 21 is supported on the projections 26 of the lower substrate support panel 20.

The method of driving the load lock having three substrate support panels 20 to 22 will be described below. The method of driving the load lock is not limited to the below description, but various driving methods are possible according to the fixing state of the substrate support panels and the coupling state of the substrate support panels with the drive units.

When one of the substrate support panels 20 to 22, for example, the first substrate support panel 20 is fixed, the second and third substrate support panels 21 and 22 move upward to load or unload the substrate onto or from the first substrate support panel 20. By the upward movement of the second and third substrate support panels 21 and 22, a space between the inside wall of the chamber 2 and the third substrate support panel 22 and a space between the second and third substrate support panels 21 and 22 are minimized, whereas a space between the first and second substrate support panels 20 and 21 is maximized, thus making a space for loading or unloading the substrate. Next, the substrate is loaded onto or unloaded from the first substrate support panel 20 by the substrate feeding unit. On the other hand, when the substrate is loaded onto or unloaded from the second substrate support panel 21, the second substrate support panel 21 moves downward to minimize the space between the first and second substrate support panels 20 and 21, and the third substrate support panel 22 moves upward to minimize the space between the third substrate support panel 22 and the inside wall of the chamber, thus maximizing the space between the second and third substrate support panels 21 and 22, and thereby making the space for loading or unloading the substrate. In such a state, the substrate is loaded onto or unloaded from the second substrate support panel 21. Further, when the substrate is loaded onto or unloaded from the third substrate support panel 22, the second and third substrate support panels 21 and 22 move downward to minimize the spaces between the first to third substrate support panels 20 to 22 and maximize the space between the third substrate support panel 22 and the inside wall of the chamber. In such a state, the substrate is loaded onto or unloaded from the third substrate support panel 22.

Furthermore, when all of the first to third substrate support panels 20 to 22 are not fixed, the vertical movement of the first substrate support panel 20 is allowed, thus making the sufficient space for loading or unloading the substrate.

With the invention not being limited to the above descriptions, the number of process chambers and the number of substrate support panels of the load lock chamber may be changed according to a process condition. As the number of substrate support panels is increased, the substrate processing capacity is enhanced. However, predetermined intervals between substrate support panels should be maintained, so that a volume of the load lock chamber is inevitably increased, the size of a gate through which the substrate is loaded or unloaded is increased. Furthermore, the drive units for driving the substrate support panels become complicated. Therefore, the number of substrate support panels should be appropriately selected considering the foregoing.

As described above, the present invention minimizes a space of a load lock chamber for loading or unloading a substrate although additional substrate support panels are provided in a load lock chamber to load a plurality of substrates, thus achieving a small load lock chamber. Thus, the present invention allows a number of substrates to be accommodated in the small load lock chamber, and shortens a pumping and exhausting time required to form a vacuum in the load lock chamber, thus enhancing productivity and saving energy.

1. A load lock, comprising:
a housing;
a first substrate support panel installed in the housing;
a second substrate support panel placed above the first substrate support panel to be spaced apart from the first substrate support panel; and
a drive unit to vertically move at least one of the first and second substrate support panels, thus making a space between the first and second substrate support panels in order to load or unload a substrate.

2. The load lock as set forth in claim 1, wherein one of the first and second substrate support panels is fixed, and the other one of the first and second substrate support panels is coupled to the drive unit and moves upward or downward, thus making the space for loading or unloading the substrate.

3. The load lock as set forth in claim 1, wherein the drive unit is coupled to each of the first and second substrate support panels, the first substrate support panel moving upward and the second substrate support panel moving downward to make the space for loading or unloading the substrate.

4. The load lock as set forth in claim 1, further comprising:
a substrate support protrusion, on which the substrate is seated, provided on each of the first and second substrate support panels to have a function of an alignment of the substrate.

5. The load lock as set forth in claim 1, further comprising:
a substrate feeding unit to load or unload the substrate onto or from each of the first and second substrate support panels; and
one or more concave parts provided on each of the first and second substrate support panels to allow the substrate feeding unit to move.

6. The load lock as set forth in claim 1, wherein each of the first and second substrate support panels comprises a cooling and/or heating unit.

7. A load lock, comprising:
a housing;
a first substrate support panel installed in the housing;
a second substrate support panel placed above the first substrate support panel to be spaced apart from the first substrate support panel;
a third substrate support panel placed above the second substrate support panel to be spaced apart from the second substrate support panel; and
a drive unit to vertically move at least one of the first to third substrate support panels, thus making a space between the first and second substrate support panels or between the second and third substrate support panels for loading or unloading a substrate.

8. The load lock as set forth in claim 7, wherein the first substrate support panel is fixed, and the drive unit comprises first and second drive units coupled to the second and third substrate support panels, respectively, the first and second drive units moving upward to make the space between the first and second substrate support panels and the space between the second and third substrate support panels, respectively, for loading or unloading the substrate.

9. The load lock as set forth in claim 7, wherein the drive unit comprises an air cylinder.

10. The load lock as set forth in claim 7, wherein each of the first to third substrate support panels comprises a cooling and/or heating unit.

11. The load lock as set forth in claim 7, wherein the first substrate support panel is fixed, and the drive unit moves horizontally in order to selectively vertically move one of the second and third substrate support panels.

12. The load lock as set forth in claim 7, wherein the first substrate support panel is smaller than the second substrate support panel, and the second substrate support panel is smaller than the third substrate support panel, in order to provide a space for accommodating the drive unit coupled at a position around an inside wall of the housing.

13. The load lock as set forth in claim 7, further comprising:
a substrate support protrusion, on which the substrate is seated, provided on each of the first to third substrate support panels to have a function of an alignment of the substrate.

14. A method of driving a load lock comprising a housing, a first substrate support panel installed in the housing, a second substrate support panel placed above the first substrate support panel to be spaced apart from the first substrate support panel, and a drive unit to vertically move at least one of the first and second substrate support panels, the method comprising:
making a space above the first or second substrate support panel for loading or unloading a substrate by moving at least one of the first and second substrate support panels upward or downward; and
loading or unloading the substrate onto or from the first or second substrate support panel.

15. A method of driving a load lock comprising a housing, a first substrate support panel installed in the housing, a second substrate support panel placed above the first substrate support panel to be spaced apart from the first substrate support panel, a third substrate support panel placed above the second substrate support panel to be spaced apart from the second substrate support panel, and a drive unit to vertically move at least one of the first to third substrate support panels, the method comprising:
making a space above one of the first to third substrate support panels for loading or unloading a substrate, by vertically moving one of the first to third substrate support panels; and
loading or unloading the substrate onto or from at least one of the first to third substrate support panels.

16. A load lock, comprising:
a plurality of substrate support panels spaced apart from each other by a interval which is larger than a thickness of a substrate, each of the substrate support panels moving vertically and supporting the substrate on an upper surface thereof; and a drive unit for vertically moving at least one of the substrate support panels.

17. The load lock as set forth in claim 1, wherein the drive unit comprises an air cylinder.
